(19) United States
(12) Patent Application Publication
(10) Pub. No.: US 2019/0362368 A1
(43) Pub. Date: Nov. 28, 2019

(54) COMPUTING ARCHITECTURE FOR MULTI-SOURCE DATA AGGREGATION AND USER-ACTION PREDICTION AND RELATED METHODS

(71) Applicant: SHOPPER ARMY INC., TORONTO (CA)

(72) Inventors: ROBERT LEVY, TORONTO (CA); JAY SHELDON, TORONTO (CA); DAVID RINKOFF, TORONTO (CA)

(21) Appl. No.: 16/420,356

(22) Filed: May 23, 2019

Related U.S. Application Data
(60) Provisional application No. 62/675,453, filed on May 23, 2018.
(60) Provisional application No. 62/717,049, filed on Aug. 10, 2018.

(51) Int. Cl. G06Q 30/02; G06F 16/22; G06F 16/2457; G06N 5/04; G06N 20/00

(52) U.S. Cl. CPC G06Q 30/0201; G06F 16/22; G06F 16/24578; G06Q 30/0224; G06N 5/04; G06N 20/00; G06Q 30/0282

(57) ABSTRACT

The system includes a communication system that continuously pulls category data for target categories from an online consumer platform at a first frequency. The communication system also continuously pulls product data for target products from a third-party data source and the online consumer platform at a second frequency, where the second frequency is higher than the first frequency. The system also includes a processor system that uses the category data and the product data to dynamically adjust a listing of target categories and a listing of target products. This data is also used to infer the actions of the users and automatically generate a predicted action for which a user can execute.

### CROSS-REFERENCE TO RELATED APPLICATIONS

This application claims priority to U.S. Patent Application No. 62/675,453 filed on May 23, 2018, titled “Computing Architecture For Multi-Source Data Aggregation And User-Action Prediction And Related Methods” and U.S. Patent Application No. 62/717,049 filed on Aug. 10, 2018, titled “Computing Architecture For Multi-Source Data Aggregation And User-Action Inference And Related Methods”, the entire contents of which are herein incorporated by reference.

### TECHNICAL FIELD

The following generally relates to computing systems for multi-source data aggregation and user-action inference, and related methods.

### DESCRIPTION OF THE RELATED ART

Computing devices and server machines use data to execute actions. It is herein recognized that available data sets are limited in their information, which in turn limits the ability for computing devices and server machines to execute actions. It is also herein recognized that data from existing user-interfacing online platforms changes over time. Trying to map this changing data and limited data from these online platforms to user data is difficult. This mapping computation is made more technically complex as the number of users increase and as the data of each user can change over time.

User data can also be used to compute inference of user actions. However, typically data is limited in frequency and in meaning, which leads to more superficial data science computations.

### BRIEF DESCRIPTION OF THE DRAWINGS

Embodiments will now be described by way of example only with reference to the appended drawings wherein:

FIG. 1 shows an example network of different computing devices for data aggregation and user action inference.

FIG. 2 shows an example computing architecture for data aggregation and user action inference.

FIG. 3 shows an example detailed computing architecture of product and categorization module shown in FIG. 2, including showing components and data flow for using machine learning to categorize and rank product data from multiple data sources.

FIG. 4 shows an example of a database shown in FIG. 3, which is for connecting product information, review information, and ranking data.

FIG. 5 shows an example aspect of FIG. 3, including using a directed graph database of processes and various weights to output a scoring metric, which are incorporated into a data pipeline.

FIG. 6 shows an example computer executable instructions for a data mining module of FIG. 3, and using outputs from the data mining module to update target points of interest.

FIG. 7 shows example components and example computer executable instructions that are implemented by the inference module shown in FIG. 2.

FIG. 8 shows another example embodiment of a data flow for executed by the product and categorization module shown in FIG. 2

FIG. 9 is an example of a user's mobile device showing a consumer research graphical user interface (GUI), including swipe gestures to indicate the user's feedback.

FIG. 10 is an example of a user's mobile device showing a consumer research GUI, including various tag input options for the user to select.

FIG. 11 is an example of a user's mobile device showing a consumer research GUI, including a mission for the user to complete one or more actions to provide feedback.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Online activities by users with real-world effects are becoming more prevalent. People use websites, for example, such as those provided by Amazon, eBay, Walmart, etc., to buy things (e.g. books, watches, household goods, pet accessories, clothing, etc.). Many of these websites limit the amount of information that they provide to external parties, for example, because these websites themselves have limited information or because there are data policies that limit the amount of information being shared.

A computing architecture is provided that addresses the limited data availability provided by online consumer platforms and that infers the user actions on these platforms.

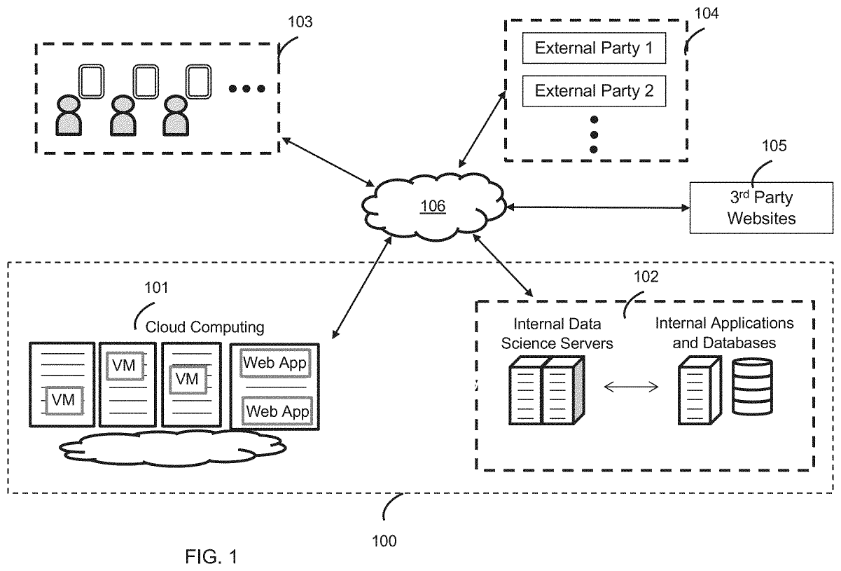

Turning to FIG. 1, an online platform 100 for aggregating data and inferring user actions is distributed across cloud computing machines 101 and internal server machines 102. For example, virtual machines and web applications are hosted on the cloud computing machines 101, and these communicate with the internal server machines 102 over a data network 106. For example, the data network 106 is the Internet. The internal server machines execute internal data science, execute internal applications, and store internal databases. One or more of these internal server machines, for example, are dedicated to one of: executing internal data science computations, executing internal applications, and storing internal databases. Different virtual machines and different web applications on the cloud computing machines 101 are, for example, dedicated to different computing modules.

The online platform 100 is accessed by user devices 103 using the web applications hosted on the cloud computing machines. User devices 103 include, for example, mobile devices, smart phones, laptops, desktop computers, smart watches, tablets, etc. In particular, user devices 103 access the one or more web applications via the data network 106.

The online platform 100 also pulls data from one or more external parties 104 (e.g. product data, service data, etc.) and incorporates this pulled data into the web application for users to access. For example, product data (e.g. product name, product image, price, product ID, product description and features, stock availability, etc.) is pulled from an external party into the online platform, processed, augmented with additional data, and then presented to a user on their user device. The product data, for example, is processed and augmented based on data that is pulled from another external party (such as a competitor's website), or pulled from one or more 3^{rd} party websites 105, or both. The online platform 100 obtains data from these different data sources frequently, in order to identify product information and their related savings. In turn, the online platform dynamically updates the ranking of the products or services that are to be displayed to users.

An external party 104 is another online platform that offers (e.g. sells, distributes, provides, etc.) products or services, or both to users. Non-limiting examples of these external parties include those websites or online platforms offered by Amazon, eBay, and Walmart. In an example involving Amazon, the online platform 100 uses Amazon Application Programming Interfaces (APIs) to pull data from the Amazon website. An external party's online platform is implemented using server machines that include their own software and databases.

The online platform 100 interacts with an external party's platform/website (e.g. Amazon's website) to augment the online shopping experience by providing the most relevant and highly ranked products or services (or both), and to also provide rewards originating from one or multiple sources to the online shopper. The rewards, for example, can be in the form of discounts from discounts, sales, points, and coupons; can originate from one or more of the product company, from Amazon, from the online platform 100, from another 3^{rd} party; and can be combined together.

In an example embodiment, a user (e.g. also called an online shopper) uses their user device 103 to purchase a product or a service via the online platform 100. The user device's web browser (e.g. an application residing on the user device) is then redirected from the online platform 100 to the external party's website to complete the purchase (e.g. make payment, provide shipping details, etc.). More generally, the user completes an obtaining action on the external party's website to obtain the product or service. For example, the obtaining action of the product or service includes a purchase of the product, or a completed ordering of the product, or a completed confirmation that the product is to be sent or picked-up by the user, or a combination thereof. In the examples herein, the obtaining action is referred to as a purchase. These examples apply to other types of obtaining actions, not necessarily including a purchase.

The details or completion of the purchase is not directly recorded by the online platform 100, since the purchase potentially takes place or took place on the external party online platform. In an example embodiment, the external party online platform does not provide confirmation or details of the purchase to the online platform 100, due to data privacy policies or other technical limitations or other policy limitations. Therefore, the online platform 100 provided herein executes computations to infer whether or not the purchase took place.

In a specific use case example involving Amazon (e.g. an external party's online platform), the online platform 100 pulls product information about a chair that is for sale on Amazon. The online platform 100 pulls product information about the same chair from different websites (e.g. Walmart, other retailers, etc.) to process and augment the chair for sale by Amazon. This processing and augmenting can include, for example, ranking the chair based on pricing and consumer reviews, as well as determining and displaying potential rewards (e.g. discounts, coupons, points, etc.). A user, using a web browser or a dedicated app on their user device, accesses a web portal provided by the online platform 100 to view the chair which is available for purchase from Amazon. Using the GUI of the online platform 100, the user selects the chair for purchase. The online platform 100 then redirects the web browser or the dedicated app to a webpage hosted by Amazon to buy the chair. The user, on the Amazon webpage, buys the chair or may decide not to buy the chair. Whether or not the user buys the chair, Amazon does not share this specific information due to data privacy policies. Therefore, the online platform 100 does not have direct confirmation from Amazon's website regarding whether or not that specific user has purchased that specific chair. To address this lack of information, the online platform 100 uses other information from Amazon in combination with other data sources (e.g. including internally tracked data) to infer whether that specific user purchased that specific chair on the Amazon website. Furthermore, if such purchase was inferred to have been made, the online platform 100 then applies the rewards to the user account of that specific user as these rewards apply to that specific chair.

It will be appreciated that while many of the examples herein relate to Amazon being the external party online platform, other companies and retailers (e.g. Walmart, eBay, etc.) can use the online platform 100 to augment the online shopping experience for users. It will also be appreciated that while many of the examples herein relate to products, the online platform 100 can also be used to augment the shopping experience for users seeking to purchase services.

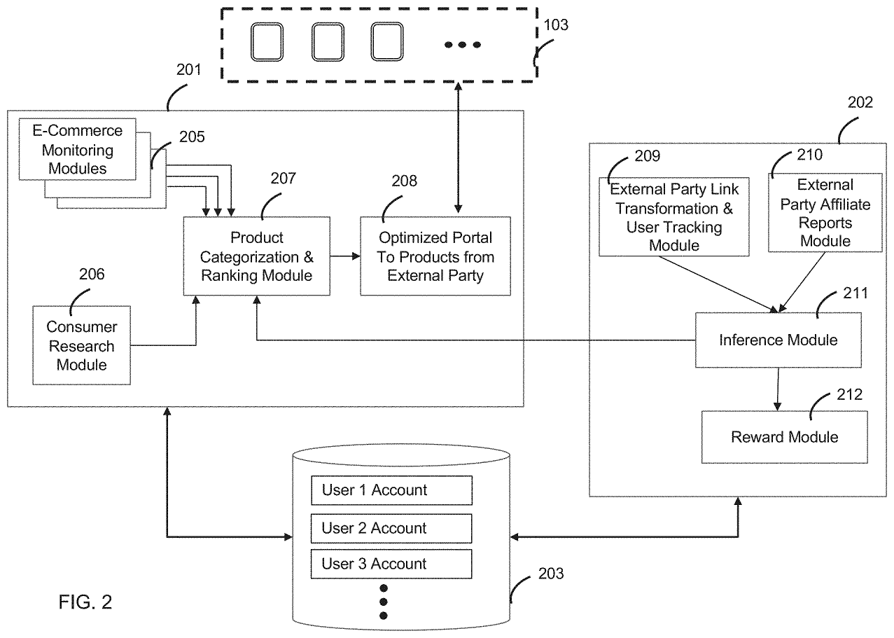

The server machines described herein include one or more processors, memory devices, and communication systems. The online platform 100 is a distributed computing system that includes distributed processors, memory devices and communication systems, as the different modules (see FIG. 2) interact with each other.

Turning to FIG. 2, an example computing architecture is shown for the online platform 100. The online platform 100 includes a grouping of modules 201 that aggregates and processes product data, including consumer research data in relation to the products, and presents the aggregated and processed product data to user devices 103 via a web portal 208. The online platform 100 also includes a grouping of modules 202 that infers whether or not a given user has purchased a given product using (i) the online platform 100 for shopping or perusing, and (ii) subsequently the external party's website (e.g. Amazon's website) to complete the purchase. This second grouping of modules 202 also applies rewards (e.g. discounts, coupons, etc.) to the given user if the purchase of the given product on the external party's website was inferred to be made. A database 203 of user accounts is used to track the interaction of each user with the online platform 100.

In particular, to aggregate product information, one or more e-commerce monitoring modules 205 pull product data. In a preferred example, there are multiple e-commerce monitoring modules which each one executing code to pull data from a different external party. For example, there is an e-commerce monitoring module for Amazon; there is another e-commerce monitoring module for Walmart; there is another e-commerce monitoring module for Costco; etc. These e-commerce monitoring modules are also considered “bots” that automatically run scripts to pull data from other parties. These e-commerce monitoring modules operate in parallel and independently from each other. In an example aspect, each of these modules pre-process the data as they pull in the data. In another example aspect, each of these e-commerce monitoring modules are implemented as different virtual machines that operate within the cloud computing machines. For example, five different e-commerce monitoring modules respectively are implemented by five different virtual machines. The parallel and independent architecture of these multiple virtual machines allows for high-bandwidth ingestion and processing of product data or service data (or both), in real-time or near real-time.

The product data includes, for example, one or more of: product name, product ID, category ID, manufacturer, product description and features, price, discounts, coupons, location, stock availability, shipping cost, ranking information, product reviews from the external party platform, etc. Other types of data can be included.

This product data is provided to a product categorization and ranking module 207.

A consumer research module 206 also provides product-related data to the product categorization and ranking module 207. For example, the consumer research module 206 uses consumer survey information to obtain user attitude data related to certain products. This user attitude data is used by the module 207 to rank the products.

A web portal 208 obtains the product data and the ranking data and automatically populates a GUI for user devices accessing the web portal 208. In other words, categories of products and products themselves are shown in the web portal, and are ordered according to their ranking.

The web portal, for example, is a web application hosted on cloud computing machines 101, and which connects to the user account database 203 so that each given user's activity on the online portal 100 is tracked with their user account.

In another process, an external party link transformation and user tracking module 209 tracks actions of a user on the online platform 100, and tracks if and when the user initiated the process to purchase a given product. The initiated purchasing process redirects the user device from the online platform's web portal to the external party online platform (e.g. Amazon's website). This redirect action from the online platform 100 to Amazon's website (or some other external party online platform) is captured by the module 209. The redirect action is also called a URL redirection or URL forwarding. In particular, the web application of the online platform 100 redirects the web browser of the given user to Amazon's website to complete the purchase, and the online platform tracks the given user's activity on the web application only up until the redirect is executed. In other words, after the redirect occurs, the online platform 100 stops tracking the user's activity. As a result, the online platform 100 cannot directly confirm whether the intended purchase is completed on Amazon's website. In an example aspect, the tracking or monitoring computations, as well as associated data storage, performed by the module 209 occur in real-time and are continuous.

The module 210 also obtains and processes affiliate reports from the external party.

The data from the modules 209 and 210 is used by the inference module 211 to infer whether or not the user did complete the purchase of the given product on Amazon's website. This inference information is also provided to the product categorization and ranking module 207. For example, if the user did purchase the given product (as inferred by module 211), then that given product may increase. This inference information is also provided to a rewards module 212, which uses this information to provide discounts, savings, rewards, etc. to the user account if the purchase was inferred to have been made.

In an example embodiment, the module 209 is part of a web application on the cloud computing machines 101; the module 210 is a virtual machine on cloud computing machines 101 or is run on internal server machines 102; the module 211 is a virtual machine on cloud computing machines 101 or is run on internal server machines 102; and the reward module 212 is part of a web application on the cloud computing machines 101.

Other implementations of the modules on virtual machines or on internal server machines, or both, can be used.

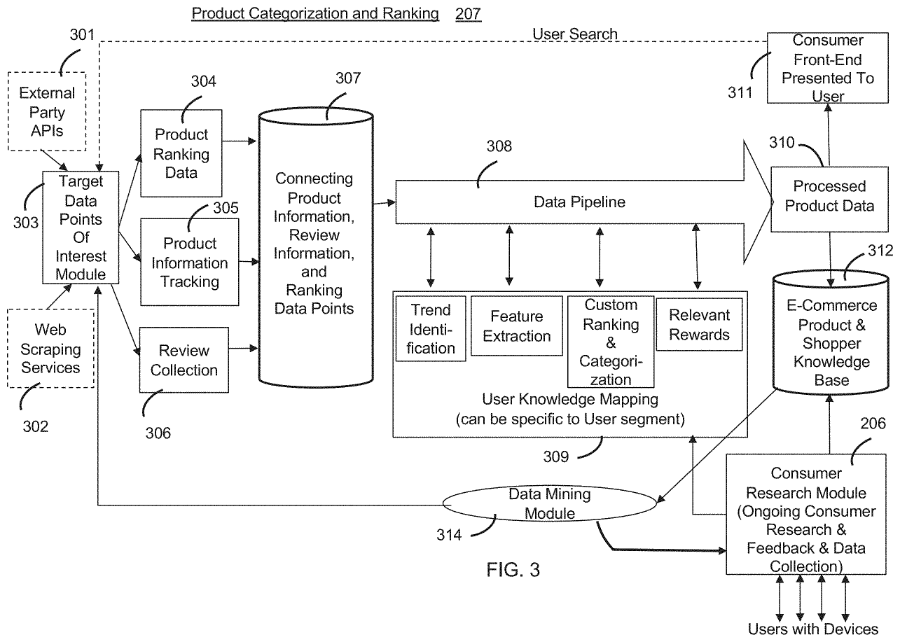

FIG. 3 shows an example embodiment of the product categorization and ranking module 207.

A target points of interest module 303 includes a listing of points of interest (POI) that are being targeted for data pulling. For example, a POI could be chairs. Therefore, product data regarding chairs are pulled from external party APIs 301 and web scraping services 302. Another POI is a brand of laundry detergent, and the module 303 interacts with the external APIs 301 and the web scraping services 302 to pull product data about that brand of laundry detergent.

In an example embodiment, the external party APIs 301 pull data from the external party's online platform at a first frequency, and the web scraping services 302 pull data at a second frequency. In an example embodiment, the first frequency is less frequent than the second frequency. In another example embodiment, the first frequency is once a day and the second frequency is once an hour. In an example aspect, the components 301, 302 are implemented as one or more e-commerce monitoring modules residing on one or more virtual machines, which can act in parallel to each other.

In another example, the data pulled into the platform by the module 303 is in real-time as new data becomes available.

In another example, the data pulled into the platform by the module 303 is based on, and in response to, a user-provided search query that is obtained via a user front-end (e.g. a GUI) 311.

The module 303 outputs product ranking data 304, product information tracking 305 and review information 306. This data 304, 305, 306 is stored in a large database 307 that links product information, review information and ranking information together. In an example embodiment, the database 307 is a relational database.

The data from the database 307 is inputted into a data pipeline 308 that processes new data as it become available. A group of different computing processes are collectively called user knowledge mapping 309. In an example aspect, some of these computing processes are specific to user segments. For example, user segments can be segmented by demographic attributes, by geographic location, by product category interest, etc. These processes process the data from the data pipeline to transform the data or add new data (e.g. metadata) or both. In another example aspect some of these computing processes can be independent, and some of these computing processes can be chained together. For processes that are chained together, for example, the output of a first process is used as the input of a second process. Consumer research data from the module 206 is also used by the one or more computing processes in the group 309.

Examples of these computing processes include trend identification, feature extraction, custom ranking, categorization, computing relevant rewards, etc.

The data pipeline 308 outputs processed product data 310, which can include transformed data and added meta data. This processed product data 310 is outputted to the consumer front-end 311, which is displayed in the GUI of the web portal 208. This processed product data 31 is also stored in an e-commerce product and shopper knowledge database 312.

Information stored in, or obtained by, or both, the consumer research module 206 is also stored in the database 312. For example, survey data, feedback data, attitude data, etc. of people in relation to products is stored in the database 312.

A data mining module 314 processes the data in the database 312 in order to gain intelligence and make modifications. In an example embodiment, the data mining module 314 executes data science and machine learning computations.

In an example embodiment, the patterns, trends, classifications, etc. that are detected by the data mining module 314 are used to update the target POIs in the module 303. For example, if a new product is becoming of greater interest to more and more users, then that new product is added as a target POI, and the module 303 starts to pull data about that new product.

In another example embodiment, the patterns, trends, classifications, etc. that are detected by the data mining module 314 are provided to the consumer research module 206. After receiving this data, the consumer research module 206 uses this data to automatically generate or modify new surveys (e.g. including new follow-up surveys) to get more consumer research. These surveys can be simple (e.g. selecting tags, like/dislike, favorite/hide, etc. to show a person's attitude regarding a product), or can be more complex (e.g. a person providing text, sentences, voice recordings, video recordings, etc. regarding their attitudes and opinions about products). For example, the module 206 can automatically define the products that are the subject of a new survey. The module 206 can automatically select the options (e.g. tags) that can be selected for the new survey. The module 206 can automatically select whether a simple survey or a more complex survey should be used to obtain research about a given product. The module 206 can also automatically assign incentives or rewards for completing the new survey. The module 206 can also automatically determine which users (e.g. which user accounts) will receive the new survey.

In another example aspect, a given user can input a search term for a product using the front-end 311. For example, the user is searching for chairs and enters a search term for chairs via the front-end 311. This search term is sent to the module 303. The module 303 then generates a chair as a target point of interest and runs one or more queries in response to receive the search term. The results of the query for the chair are tagged for the given user. These results include product ranking data 304, product information tracking 305, and review collection 306. These results are also stored in the database 307 and processed according to the data pipeline 308 as noted above. The processed product data for the chairs, which continue to be tagged for the given user, are then outputted to the front-end 311 for the given user. In this way, the user is able to see rewards, rankings, trends, etc. that are associated with chairs. This process of searching and returning the search results, for example, occurs quickly or in realtime.

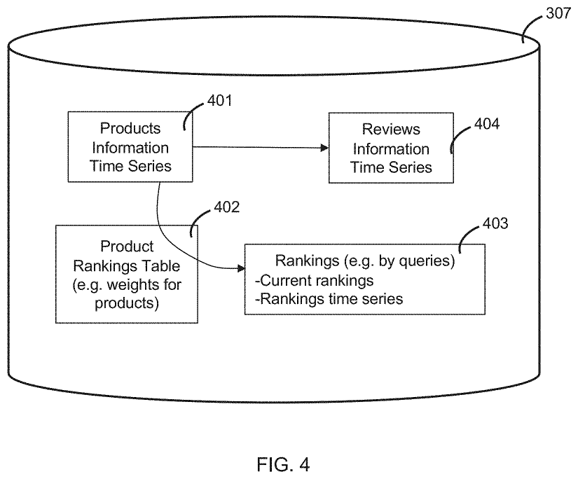

Turning to FIG. 4, an example embodiment of the database 307 is shown. It is a large relational database that includes, amongst other things, product information database 401 regarding different products and arranged as a time series. The database 307 also includes a reviews information database 404, where the review information is associated with each product and is arranged as a time series. The database 307 also includes a rankings information database 403, where the ranking information is associated with each product. The rankings include the current rankings and a time series of the past rankings. The rankings, for example, are by queries of a product (e.g. most queried), by products most purchased, by products with highest user ratings, etc. The rankings database 403 is related to a product ranking table 402, and this table 402 in turn is related to the product information database 401. The table 402, for example, includes weights for each of the products, and these weights are used to adjust the ranking scores of the products.

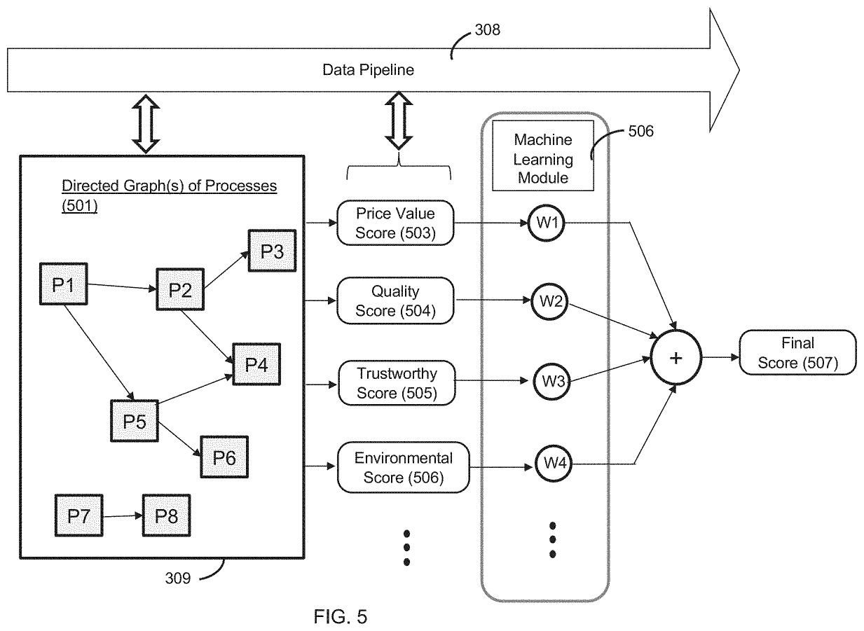

Turning to FIG. 5, an example embodiment of the data pipeline 308 with the grouping of computing processes 309 is shown. In this example aspect, the computing processes P1, P2, P3, P4, . . . P8 etc. are stored as nodes of a directed graph database 501. In particular, nodes of the directed graph database respectively store the executable instructions of different processes. For example, the computing process P1 is stored as one node, the computing process P2 is stored as another node, the computing process P3 is stored as another node, and so forth. The directed edges between the nodes show how the inputs and outputs of each process are related, or chained together. For example, in FIG. 5, the output of P1 is used an input to P2, and the output of P2 is used as an input into P4. Similarly, the output of P1 is used as input to P5, and the output of P5 is used as input into P4. Therefore, P4 takes the outputs of both P2 and P5 to compute its own output.

There may be two or more separate directed graphs in the database 501. For example, the computing processes P7 and P8 form their own directed graph.

The outputs from one or more of these various sequences of processes are used to compute different scores, such as a price value score 503, a market strength score 504, a trustworthy score 505, an environmental score 506, etc. These scores are modified according to weights W1, W2, W3, W4, etc. (e.g. by taking the product of a score and a given weight), and the weighted scores are then summed to output a final score 507. This final score is used to rank a product, which then affects how the product is displayed on the web portal. For example, higher ranked products are shown first or earlier on a list of available products.

In an example embodiment, the weights are statically determined. In another example embodiment, a machine learning module 506 uses consumer research data from the module 206, and data from the e-commerce product and shopper knowledge base 312 to dynamically compute the weights. In other words, the weights automatically change over time as new information becomes available.

For example, it may be discovered over time from consumer research data (e.g. from automated surveys) that people now strongly favor product quality over pricing. This insight could also be obtained or verified by looking at quality rankings versus price rankings, which could reveal that people have historically purchased higher quality products having a higher prices, compared to lower quality products with lower prices. The machine learning could determine that such behavior occurs for a certain product, or for a certain category of products. Therefore, the weighting W2 for the quality score 504 is automatically increased and the weighting W1 for the price value score W1 is automatically decreased.

In another example aspect of the machine learning module 506, a neural net model is trained using product attributes and user characteristics to predict the weights. Therefore, the following computing process automatically occurs:

Operation 1: For each given target product to be displayed to a given user:
Step A: input the target product attributes and the given user attributes into the deep learning neural net model;
Step B: output from the neural net model the predicted weights;
Step C: for the given target product, apply the predicted weights to compute the final score (507)

Operation 2:
Step A: Rank or order all target products by their respective final scores
Step B: Display target products according to their rank to the given user.
   The display of target products according to their rank includes, in an example aspect, displaying only the top N ranked products, where N is a natural number. It will be appreciated that this process is repeated on a per user basis, and thus, the display of ranked products is customized to each user.

In an example embodiment, the price value score also takes into account available rewards. In particular, as part of the online platform's data aggregating, the online platform 100 also identifies sale prices, discounts, coupon prices, points, cash-back offers, and the like. These savings may come from multiple sources. For example, a sale price comes from a first data source, the coupon comes from a second data source, and a cash-back offer comes from a third data source. As part of the data aggregation, the online platform 100 maps these savings to a single product, and shows a sum total of the savings for the given product. This sum total of savings and the final price are factored into the computation of the price value score. For example, a rewards computing process aggregates the total rewards from different sources as applicable to a given product.

In a further aspect of the rewards, after the online platform infers that a user did in fact complete the obtaining action on Amazon (e.g. completed the purchase of the product, or completed the ordering of the product, or completed a confirmation action that the product is to be sent or is to be picked-up by the user), the online platform 100 applies the rewards to the user. The online platform 100 also transmits the purchase information (e.g. details regarding the purchase of the product by the given user) to the respective different data sources, so that their respective records can be updated.

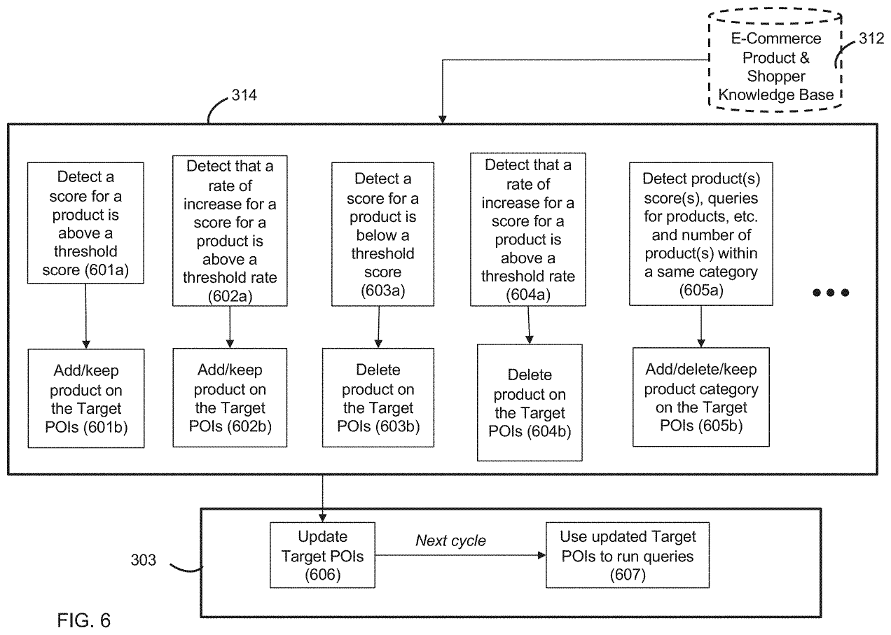

FIG. 6 shows an example embodiment of the data mining module 314, which pulls data from the e-commerce product and shopper knowledge database 312.

The data mining module 314 executes various data science algorithms to mine insights from the data in the database 312. Based on what data changes are detected, products are added or deleted on the list of target POIs.

For example, the module 314 detects that a score for a product is above a threshold score (block 601a), and then adds/keeps the product on the target POIs (block 601b).

For example, the module 314 detects that a rate of increase for a score for a product is above a threshold rate (block 602a), and then adds/keeps the product on the target POIs (block 602b).

For example, the module 314 detects that a score for a product is below a threshold score (block 603a), and then deletes the product from the target POIs (block 603b).

For example, the module 314 detects that a rate of increase for a score for a product is above a threshold rate (block 604a), and then deletes the product from the target POIs (block 604b).

For example, the module 314 monitors one or more product scores, queries for one or more products, etc. In another example aspect, the module 314 also does the same monitoring and querying for a number of products within a same category (block 605a). Based on the scores, queries and overall number of products within the same product category, the module 315 then adds or deletes or keeps the category in the target POIs (block 605b).

The target POI module 303 then updates the target POIs (block 606) based on the commands from the data mining module 314. At a next data mining or data pulling cycle, the module 303 uses the updated target POIs to run queries via the e-commerce monitoring modules (block 607).

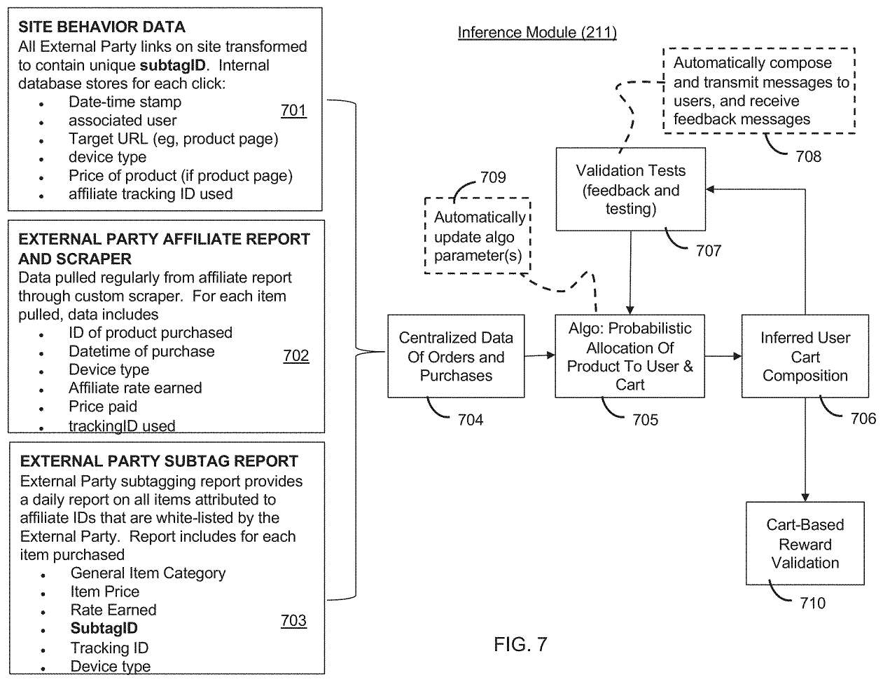

Turning to FIG. 7, an example data flow is shown for executing instructions by the inference module 211.

The online platform 100 stores actions and related information with respect to a user using the web portal 208. In particular, as a product on Amazon (or some other external party) is shown on the web portal 208, a custom data link (e.g. a customized Uniform Resource Locator also called a URL) to the product on Amazon's website is embedded into the GUI of the online platform's web portal 208. In this way, when a user clicks or selects that data link, the user web browser or application is switched from the online platform 100 to the webpage of the product on Amazon's website.

The online platform 100 generates a custom data link for each product that is able to redirect the web browser to Amazon's webpage containing the given product. Each custom data link also includes a unique subtagID. In other words, the subtagID of the product is included in the data link to Amazon. The subtagID is a unique key that is generated by the online platform 100 for the purpose of tracking a purchase. The subtagID is passed to Amazon in the URL, and identifies which session an item was purchased during in the purchase report Amazon provided to the online platform 100. This allows the online platform 100 to match the purchase back to a Trip model saved in the online platform's database. This Trip model records the subtagID that was used, the user who started the trip, the timestamp of the trip, and any other information such as what product ID or search term they started their trip with.

The online platform 100 tracks and stores the following example information in association with the subtagID: date-time stamp of a click/selection (e.g. which triggers to the redirect to Amazon); associated user account ID that is making the click/selection; target URL of the Amazon destination page (either product page, search page, or other landing page on Amazon); device type being used by the user; price of the product clicked/selected; and affiliate tracking ID if available/used. Other information can be tracked by the online platform.

In an example aspect, the intake and pre-processing of the above site behavior data 701 is executed by the module 209.

A separate data mining or data pulling process take place via a custom data scraper module 702 that operates on the online platform 100. The online platform 100 obtains affiliate reports from Amazon (e.g. on a daily frequency or some other time interval) and the custom scraper 702 pulls the data from the affiliate reports, including: ID of product purchased on Amazon; date-time stamp of product purchased on Amazon; device type used to make the purchase on Amazon; affiliate rate earned; price paid; tracking ID used; etc.

An external party subtagging report 703 (e.g. a subtagging reporting from Amazon) is also obtained on a regular basis (e.g. daily basis), which includes all products attributed to the affiliate IDs and that are white listed by the external party. This subtagging reporting includes, for each item purchased, the following example data: general item category; item price; rate earned; subtagID; tracking ID; and device type.

In an example aspect, the intake and pre-processing of the data related to the data scraper module 702 and the data from the subtagging report 703 are executed by the module 210.

In isolation, the data from the site behavior data 701, or the data obtained by the scraper from the affiliate report 702, or the subtag report 703 is unable to provide enough data for the inference module to infer whether or not a user completed the purchase on Amazon. However, in aggregate, the inference module 211 is able to make such a determination.

In particular, the above data is collected and stored in a centralized data repository of orders and purchases 704. A computing module 705 accesses this centralized data repository to compute a probabilistic value or score that a given product that was purchased on Amazon was made in connection to a given user account (and their online “shopping cart”) on the online platform 100.

For example, the module 705 identifies if different data features, match or are similar. For example, the device type should be the same from the different sources. The subtagID should be the same from the different sources. The pricing should be the same from the different sources. The date-time stamp from the site behavior data 701 (e.g. called the first date-time stamp) and the date-time stamp of purchase from the affiliate report 702 (e.g. called the second date-time stamp) should be within some time difference of X number of minutes of each other, where the first date-time stamp must precede the second date-time stamp. For example, the value X could be hardcoded. In another example, the value X is machine learned to match people's buying habits. In other words, if the second date-time stamp is too long (e.g. more than X minutes) after the first date-time stamp, then the purchase recorded on Amazon is less likely to be attributed or associated with the intent to purchase (e.g. a site behavior action tracked by a click/selection) recorded on the online platform 100.

In an example aspect, the module 705 executes a matching algorithm that is based on a number of ‘hard’ matching criteria and ‘soft’ matching criteria to limit the possible matched purchases down to as few maximal likely candidates as possible. Hard matching criteria include: price, device type, product category, and purchase date. Soft matching criteria include cart level matching and historical member activity.

An output 706 is provided that includes a composition of products that have been inferred to have been purchased on Amazon by each given user. For the products that have been inferred to have been purchased by a given user on Amazon and initiated via the online platform 100, as determined by the output 706, then rewards (e.g. discounts, coupons, points, etc.) are provided to the user account (on the online platform 100) of the given user. This process of allocating rewards is called cart-based reward validation (block 710).

The output 706 is also used at block 707 to generate validation tests (e.g. feedback and testing) to improve the inference algorithm of the module 705. For example, as part of the validation tests, the online platform 100 automatically composes and transmits messages (e.g. emails or other electronic messages) to users to confirm whether or not they purchased the product on Amazon for which they were viewing earlier on the online platform 100 (block 708). The user provides a confirmation response or a denial response to these messages. This feedback is used by the module 705 to automatically update the inference algorithm parameters (block 709). For example, the value X regarding the time difference could be automatically adjusted based on the validation data.

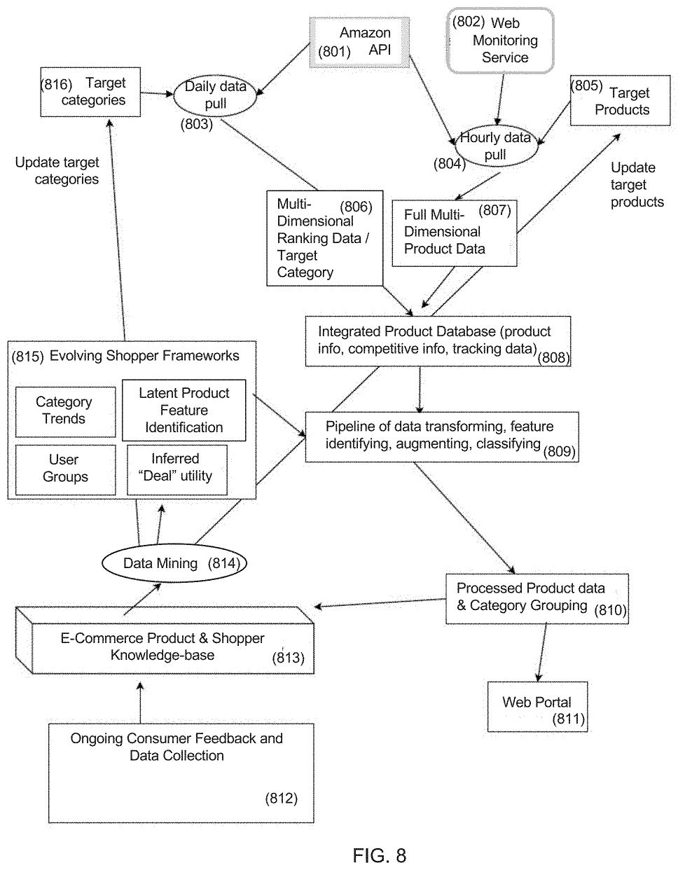

Turning to FIG. 8, another example embodiment of a data flow is shown, which is executed by the product and categorization module shown in FIG. 2.

In FIG. 8, the online platform 100 uses the Amazon API 801 and a web monitoring service 802 to execute a data pull from these difference web platforms (block 804). For example, the data pull is product information for targeted products 805. The data pull could be performed hourly, for example, or at some other frequency.

The resulting data from block 804 is full multi-dimensional product data 807. In a parallel process, the online platform also performs a daily data pull operation (block 803) via the Amazon API 801, which results in multi-dimensional ranking data for targeted product categories. In other words, within a given product category, the ranking of products in that category is provided.

At block 808, the data flows 806 and 807 are stored in an integrated product database (e.g. including product information, competitive information, and tracking data). This data is then inputted into a data pipeline for transforming, feature identifying, augmenting, and classifying (block 809). Data from evolving shopper frameworks 815 is also supplied to the data pipeline.

At block 810, the data pipeline outputs the processed product data and category groupings. This information is supplied to the web portal at block 811. This information is also supplied to the e-commerce product and shopper knowledge database at block 813. In an example aspect, ongoing consumer research and feedback data is also being inputted into the e-commerce product and shopper knowledge database at block 812.

At block 814, the online platform executes data mining algorithms on the e-commerce product and shopper knowledge database to update the targeted products being queried or pulled from other websites. The outputs of the data mining algorithms are also used, for example, to update the targeted product categories 816, which dictate the queries for the rankings in the data pulls (block 803).

The outputs of the data mining algorithms are also used to update the evolving shopper frameworks at block 815. For example, these frameworks include category trends, latent product feature identification, user groups, and inferred “Deal” utility.

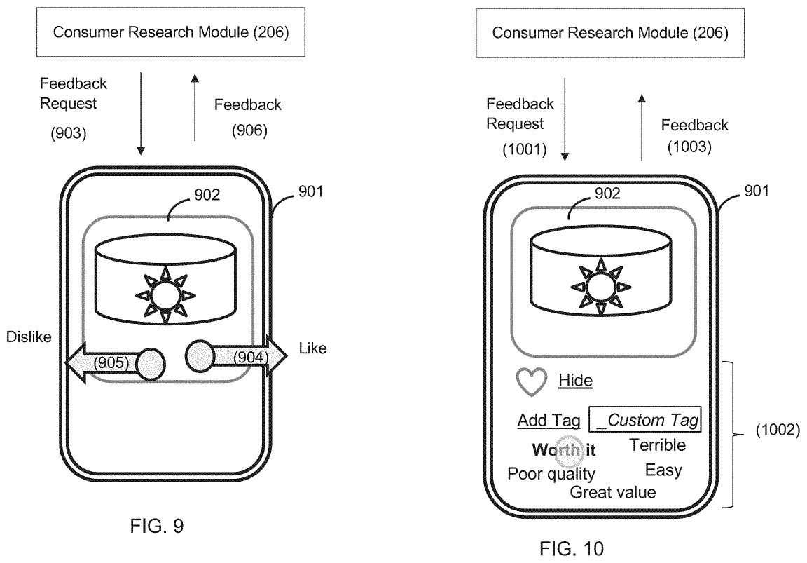

FIGS. 9 to 11 show examples of GUIs used by the online platform 100 to request feedback about certain products. This request for feedback is considered consumer research media (e.g. electronic surveys). These surveys are published over the network 106, and the feedback is processed and stored, by the consumer research module 206. As noted above, in an example embodiment, the electronic surveys can be automatically generated using machine learning to target specific products, or categories of products, etc., as well as to target certain users.

FIG. 9 shows a mobile device 901 of a user (e.g. also more generally called a user device) that includes a display screen showing an image of a product 902. This image 902 is shown as part of a feedback request survey that has been transmitted by the online platform 100 to the mobile device 901 (operation 903). A user can swipe in one direction (e.g. swipe right) to indicate that they like the product, or can swipe in an opposite direction (e.g. swipe left) to indicate that they do not like the product. This user interaction is very quick and easy. The mobile device 901 then transmits back the user's opinion (e.g. like or dislike) to the online platform (operation 906).

FIG. 10 shows a different survey that has been transmitted to the mobile device (operation 1001). The survey includes the image of the product and different options 1002 to tag the product. The options include: a heart, an option to hide the product, word tags that describe how a person feels about the product, and a field to add a custom tag. For example, the user selects the displayed word tag “Worth it”, and this feedback that includes this selected tag is sent back to the online platform (operation 1003). In an example aspect, the displayed word tag options are automatically generated using machine learning algorithms executed by the consumer research module 206.

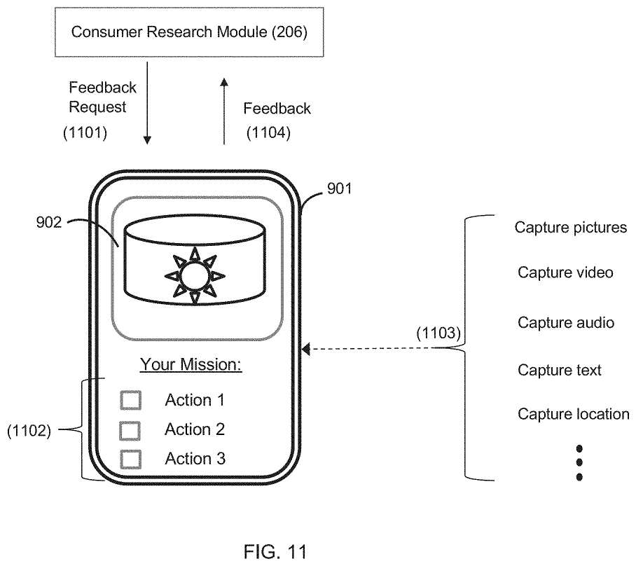

FIG. 11 shows a different survey that has been transmitted to the mobile device (operation 1101). The survey is called a “mission”, in which the user needs to complete a set of actions 1102 in relation to the product. In the course of completing these actions, the mobile device 901 is used to capture data, include one or more of: capture pictures, capture video, capture audio, capture text, and capture location. The audio data, visual data, text data, location data, or a combination thereof, is sent back to the online platform 100 as feedback (operation 1104). For example, an action includes taking a video of a product and commenting on the packaging, or commenting on the quality of the product. The online platform 100, for example, uses image recognition to confirm that the product in the video matches the product shown in the image 902. Speech-to-text processing is applied to the video to obtain content feedback and sentiment feedback; this feedback includes what the user is saying with respect to the product and how they feel about the product (e.g. happy, content, neutral, frustrated, angry, confused, disappointed, etc.).

It is appreciated that these computing and software architectures are for example. Other architectures can also be used to accelerate the processing of data.

Below are example general embodiments and their example aspects.

In a general example embodiment, a computing system is provided that includes: multiple modules for ingesting data about products in parallel; a database that stores the ingested data as a time series, and organized in relation to each product; a data pipeline integrated with different computing processes to compute metadata associated with each product; and a web application to display the products in a ranked order that is computed using the metadata associated with each product. After the web application detects that a given user has selected to complete an obtaining action for a given product, the web application redirects a web browser of the given user to an external party website to complete the obtaining action, and the computing system tracks the given user's activity on the web application up until the redirect is executed. The computing system records site behavior data of the given user. This site behavior data includes, for example, a date-time stamp of the redirect, a product ID of the given product, a price of the given product, and a user account ID of the given user. The site behavior data is compared against data provided by the external party website to infer whether or not the given user completed the obtaining action of the product and/or other products on the external party website.

For example, the obtaining action of the product is a purchase of the product, or a completed ordering of the product, or a completed confirmation that the product is to be sent or picked-up by the user, or a combination thereof.

In an example aspect, an affiliate reports module that ingests external reports and identifies information that includes, for example, a date-time stamp of a product purchase made on the external party website, a product ID associated with the obtaining action made on the external party website, and a price associated with the obtaining action made on the external party website. The computing system further includes an inference module that infers whether or not the given user completed the obtaining action of the given product on the external party website by executing comparison computations that include: (i) the date-time stamp of the redirect compared with the date-time stamp of the obtaining action made on the external party website, (ii) the product ID of the given product compared with the product ID associated with the obtaining action made on the external party website, and (iii) the price of the given product compared with the price associated with the obtaining action made on the external party website.

In a further example aspect, the comparison computations include determining that if the date-time stamp of the obtaining action made on the external party website is within a threshold amount of time (e.g. X minutes) after the date-time stamp of the redirect, then the given user likely completed the obtaining action for the given product on the external party website.

In a further example aspect, the inference module automatically generates and transmits a message to the given user to obtain feedback that confirms if they completed the obtaining action of the given product; and the inference module inputs the feedback in a machine learning process to update the threshold amount of time.

In a further example aspect, the site behavior data further includes a device type of the given user. The affiliate reports module further identifies a device type associated with the obtaining action made on the external party website. The comparison computations further comprise (iv) the device type of the given user compared with the device type associated with the obtaining action made on the external party website.

In another example aspect, the system further includes a rewards module, and wherein after the inference module infers that the given user completed the obtaining action for the given product on the external party website, the rewards module assigns one or more rewards to the user account ID of the given user.

In another general example embodiment, a computing system includes: a communication system that continuously pulls category data for target categories from an online consumer platform at a first frequency; the communication system that continuously pulls product data for target products from a third-party data source and the online consumer platform at a second frequency, where the second frequency is higher than the first frequency; and a processor system that uses the category data and the product data to dynamically adjust a listing of target categories and a listing of target products.

In another general example embodiment, a computing system includes: multiple modules for ingesting data about products in parallel; a database that stores the ingested data as a time series, and organized in relation to each product; a data pipeline integrated with one or more directed graphs of different computing processes to compute metadata associated with each product, wherein each directed graph comprises multiple nodes respectively storing the different computing processes and further comprises directed edges between the multiple nodes to define input-output relationships between the different computing processes; and a web application to display the products in a ranked order that is computed using the metadata associated with each product.

In an example aspect, the multiple modules include multiple virtual machines on cloud computing server machines, and the multiple virtual machines respectively obtain data from multiple different websites.

In another example aspect, different combinations of computing processes in the data pipeline are used to respectively compute different scores; and weights are applied to the different scores to compute a final score associated with each product, which is used to determine the ranked order of the products.

In a further example aspect, the weights are dynamically computed using a neural network that predicts the weights using attributes of a given product and attributes of a given user.

In another example aspect, the system further includes a consumer research module that uses the data in the database to generate and transmit electronic surveys to users regarding specific ones of the products, and that receives and stores feedback data from the electronic surveys. At least one of the computing processes integrated in the data pipeline pulls the feedback data to compute the metadata.

In a further example aspect, the consumer research module uses the data in the database and the metadata to automatically generate and transmit electronic surveys to the users.

In another example aspect, after the web application detects that a given user has selected to obtain a given product, the web application redirects a web browser of the given user to an external party website to complete an obtaining action of the given product, and the computing system only tracks the given user's activity on the web application up until the redirect is executed. The computing system records information such as a date-time stamp of the redirect, a product ID of the given product, a price of the given product, and a user account ID of the given user.

In a further example aspect, the system further includes an affiliate reports module that ingests external reports and identifies information that includes, for example, a date-time stamp of a product purchase made on the external party website, a product ID associated with the product purchase made on the external party website, and a price associated with the product purchase made on the external party website. The computing system further includes an inference module that infers whether or not the given user completed purchasing the given product on the external party website by executing comparison computations, and the comparison computations include: (i) the date-time stamp of the redirect compared with the date-time stamp of the product purchase made on the external party website, (ii) the product ID of the given product compared with the product ID associated with the product purchase made on the external party website, and (iii) the price of the given product compared with the price associated with the product purchase made on the external party website.

In a further example aspect, the comparison computations include determining that if the date-time stamp of the product purchase made on the external party website is within a threshold amount of time after the date-time stamp of the redirect, then the given user likely purchased the given product on the external party website.

In a further example aspect, the inference module automatically generates and transmits a message to the given user to obtain feedback that confirms if they purchased the given product; and the inference module inputs the feedback in a machine learning process to update the threshold amount of time.

In a further example aspect, the system further includes a rewards module, and wherein after the inference module infers that the given user purchased the given product on the external party website, the rewards module assigns one or more rewards to the user account ID of the given user.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing system comprising:
multiple modules for ingesting data about products in parallel;
a database that stores the ingested data as a time series, and organized in relation to each product;
a data pipeline integrated with different computing processes to compute metadata associated with each product; and
a web application to display the products in a ranked order that is computed using the metadata associated with each product;
wherein after the web application detects that a given user has selected to obtain a given product, the web application redirects a web browser of the given user to an external party website to complete an obtaining action of the given product, and the computing system tracks the given user's activity on the web application up until the redirect is executed; wherein the computing system records site behavior data of the given user and the site behavior data comprises: a date-time stamp of the redirect, a product ID of the given product, a price of the given product, and a user account ID of the given user; and wherein the site behavior data is compared against data provided by the external party website to infer whether or not the given user completed the obtaining action of the given product on the external party website.

2. The computing system of claim 1 comprising an affiliate reports module that ingests external reports and identifies information comprising: a date-time stamp of the obtaining action of the given product made on the external party website, a product ID associated with the obtaining action of the given product made on the external party website, and a price associated with the obtaining action of the given product made on the external party website; and the computing system further comprising an inference module that infers whether or not the given user completed the obtaining action of the given product on the external party website by executing comparison computations that comprise (i) the date-time stamp of the redirect compared with the date-time stamp of the obtaining action made on the external party website, (ii) the product ID of the given product compared with the product ID associated with the obtaining action made on the external party website, and (iii) the price of the given product compared with the price associated with the obtaining action made on the external party website.

3. The computing system of claim 2 wherein the comparison computations include determining that if the date-time stamp of the obtaining action made on the external party website is within a threshold amount of time after the date-time stamp of the redirect, then inferring that the given user has completed the obtaining action of the given product on the external party website.

4. The computing system of claim 3 wherein the inference module automatically generates and transmits a message to the given user to obtain feedback that confirms if the obtaining action of the given product has been completed; and the inference module inputs the feedback in a machine learning process to update the threshold amount of time.

5. The computing system of claim 2 wherein the site behavior data further includes a device type of the given user; wherein the affiliate reports module further identifies a device type associated with the obtaining action of the given product made on the external party website; and wherein the comparison computations further comprise (iv) the device type of the given user compared with the device type associated with the obtaining action made on the external party website.

6. The computing system of claim 1 further comprising a rewards module, and wherein after the inference module infers that the given user has completed the obtaining action of the given product on the external party website, the rewards module assigns one or more rewards to the user account ID of the given user.

7. A computing system comprising:
a communication system that continuously pulls category data for target categories from an online consumer platform at a first frequency;
the communication system continuously pulling product data for target products from a third-party data source and the online consumer platform at a second frequency, where the second frequency is higher than the first frequency; and
a processor system that uses the category data and the product data to dynamically adjust a listing of target categories and a listing of target products.

8. A computing system comprising:
multiple modules for ingesting data about products in parallel;
a database that stores the ingested data as a time series, and organized in relation to each product;
a data pipeline integrated with one or more directed graphs of different computing processes to compute metadata associated with each product, wherein each directed graph comprises multiple nodes respectively storing the different computing processes and further comprises directed edges between the multiple nodes to define input-output relationships between the different computing processes; and
a web application to display the products in a ranked order that is computed using the metadata associated with each product.

9. The computing system of claim 8 wherein the multiple modules include multiple virtual machines on cloud computing server machines, and the multiple virtual machines respectively obtain data from multiple different websites.

10. The computing system of claim 8 wherein different combinations of computing processes in the data pipeline are used to respectively compute different scores; and weights are applied to the different scores to compute a final score associated with each product, which is used to determine the ranked order of the products.

11. The computing system of claim 10 wherein the weights are dynamically computed using a neural network that predicts the weights using attributes of a given product and attributes of a given user.

12. The computing system of claim 8 further comprising a consumer research module that uses the data in the database to generate and transmit electronic surveys to users regarding specific ones of the products, and that receives and stores feedback data from the electronic surveys; and at least one of the computing processes integrated in the data pipeline pulls the feedback data to compute the metadata.

13. The computing system of claim 12 wherein the consumer research module uses the data in the database and the metadata to automatically generate and transmit electronic surveys to the users.

14. The computing system of claim 8 wherein, after the web application detects that a given user has selected to obtain a given product, the web application redirects a web browser of the given user to an external party website to complete an obtaining action of the given product, and the computing system only tracks the given user's activity on the web application up until the redirect is executed; and wherein the computing system records information comprising: a date-time stamp of the redirect, a product ID of the given product, a price of the given product, and a user account ID of the given user.

15. The computing system of claim 14 comprising an affiliate reports module that ingests external reports and identifies at least: a date-time stamp of the obtaining action of the given product made on the external party website, a product ID associated with the obtaining action made on the external party website, and a price associated with the obtaining action made on the external party website; and the computing system further comprising an inference module that infers whether or not the given user completed the obtaining action for the given product on the external party website by executing comparison computations that comprise (i) the date-time stamp of the redirect compared with the date-time stamp of the obtaining action made on the external party website, (ii) the product ID of the given product compared with the product ID associated with the obtaining action made on the external party website, and (iii) the price of the given product compared with the price associated with the obtaining action made on the external party website.

16. The computing system of claim 15 wherein the comparison computations include determining that if the date-time stamp of the obtaining action made on the external party website is within a threshold amount of time after the date-time stamp of the redirect, then the given user likely completed the obtaining action for the given product on the external party website.

17. The computing system of claim 16 wherein the inference module automatically generates and transmits a message to the given user to obtain feedback that confirms if they completed the obtaining action of the given product; and the inference module inputs the feedback in a machine learning process to update the threshold amount of time.

18. The computing system of claim 15 further comprising a rewards module, and wherein after the inference module infers that the given user completed the obtaining action for the given product on the external party website, the rewards module assigns one or more rewards to the user account ID of the given user.
